(19) United States
(12) Patent Application Publication
(10) Pub. No.: US 2026/0343305 A1
(43) Pub. Date: Oct. 29, 2026

(54) RADIO UNIT SERVICE RECOVERY USING EFFICIENT AUTO-CONFIGURATION

(71) Applicant: Dell Products L.P., Round Rock, TX (US)

(72) Inventors: Thang Pham, Dollard-des-Ormeaux (CA); Ravi Sharma, Cupertino, CA (US); Afshin Sahabi, Ottawa (CA); Vikas Arora, Ottawa (CA); Alvaro de Jodra, Prosper, TX (US)

(21) Appl. No.: 19/186,984

(22) Filed: Apr. 23, 2025

(51) Int. Cl. H04W 28/02; H04W 28/18

(52) U.S. Cl. CPC H04W 28/0215; H04W 28/18

(57) ABSTRACT

Technologies described herein can reconfigure a radio unit (RU) of a radio system following RU reset. An example radio system can comprise a distributed unit of a cell of the radio system, the distributed unit comprising at least one processor and at least one memory communicatively coupled to the at least one processor, and a radio unit of the cell, wherein the distributed unit detects that the radio unit has been reset, and wherein the distributed unit, in response to detecting that the radio unit has been reset, reconfigures the radio unit.

### BACKGROUND

Modern cellular systems continue to advance, where updates, including hardware, software, and/or a combination thereof, can improve one or more aspects and/or to provide one or more new services and/or other aspects. Addressing of service downtime is one of these aspects that can be improved to allow for reduced and/or eliminated downtime to one or more user entities due to software and/or hardware reset and/or reconfiguration of a cellular system.

### SUMMARY

The following presents a simplified summary of the disclosed subject matter to provide a basic understanding of one or more of the various embodiments described herein. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

Generally provided is an implementation framework comprising a system, method and/or non-transitory computer-readable medium to reconfigure a radio unit (RU) following RU reset. Different from existing frameworks where an open radio access network (O-RAN) only mandates an RU to persist a small subset of configurations and where upon RU reset a higher radio system layer would be employed to reconfigure the RU again, the one or more embodiments described herein can employ a combination of a service management and orchestration unit (SMO) and distributed unit (DU) of a respective radio system to reconfigure the RU. Instead, the reconfiguration using the SMO/DU can generally employ a hierarchical framework of the radio system in an efficient manner, reducing service interruption time and/or enhancing the O-RAN’s reliability by reducing dependencies on the SMO.

An example radio system can comprise a distributed unit of a cell of the radio system, the distributed unit comprising at least one processor and at least one memory communicatively coupled to the at least one processor, and a radio unit of the cell, wherein the distributed unit detects that the radio unit has been reset, and wherein the distributed unit, in response to detecting that the radio unit has been reset, reconfigures the radio unit.

Another example radio system can comprise a distributed unit of a cell of the radio system, the distributed unit comprising at least one processor and at least one memory communicatively coupled to the at least one processor; and a radio unit of the cell, and a service, management and orchestration unit (SMO) of the cell, wherein the distributed unit, the radio unit, and the SMO are communicatively coupled to one another, wherein the distributed unit notifies the SMO of a capability of the distributed unit to reconfigure the radio unit, wherein the SMO makes a determination not to perform reconfiguration of the radio unit by the SMO, wherein the SMO confirms the capability of the distributed unit to the distributed unit, and wherein the distributed unit performs the reconfiguration of the radio unit instead of the SMO performing the reconfiguration of the radio unit.

An example method can comprise determining, by a distributed unit of a cell of a radio system, that a radio unit of the cell has been reset, generating, by the distributed unit, a notification, communicated to the cell, that the radio unit has been reset, and based on the radio unit having been reset, reconfiguring, by the distributed unit, the radio unit.

A benefit of the one or more example described herein can comprise, but is not limited to, shortening of UE disconnection to a cell after RU reconfiguration.

Another benefit of the one or more example described herein can comprise, but is not limited to, can be lack of reliance on the O1 connection, which as noted above, can be unreliable. That is, even if an O1 connection is down, RU reconfiguration/configuration can proceed via the DU.

Still another benefit of the one or more example described herein can comprise, but is not limited to, employing timestamps, allowing for the DU to verify if the RU has been additionally reset or recovered. That is, blind configuration/reconfiguration of the RU can be avoided.

### BRIEF DESCRIPTION OF THE DRAWINGS

The technology described herein is illustrated by way of example, and not limited to the accompanying figures, in which like reference numerals indicate similar elements.

FIG. 1 illustrates an example schematic representation of example elements of a radio system, in accordance with one or more embodiments and/or implementations described herein.

FIG. 2 illustrates another example schematic representation of example elements of the radio system of FIG. 1, in accordance with one or more embodiments and/or implementations described herein.

FIG. 3 illustrates an example schematic diagram of an existing radio unit configuration framework, in accordance with one or more embodiments and/or implementations described herein.

FIG. 4 illustrates an example schematic diagram of a non-limiting radio unit reset system, in accordance with one or more embodiments and/or implementations described herein.

FIG. 5 illustrates an example schematic diagram of a radio unit configuration framework that can be employed by the radio unit reset system of FIG. 4, in accordance with one or more embodiments and/or implementations described herein.

FIG. 6 illustrates another example schematic diagram of a radio unit configuration framework that can be employed by the radio unit reset system of FIG. 4, in accordance with one or more embodiments and/or implementations described herein.

FIG. 7 illustrates a process flow diagram of a method of reconfiguring a radio unit of a radio system after reset of the radio unit, such as using the radio unit reset system of FIG. 4, in accordance with one or more embodiments and/or implementations described herein.

FIG. 8 illustrates a continuation of the process flow diagram of a FIG. 7 of a method of reconfiguring a radio unit of a radio system after reset of the radio unit, in accordance with one or more embodiments and/or implementations described herein.

FIG. 9 illustrates a block diagram of an example operating environment into which embodiments of the subject matter described herein can be incorporated.

FIG. 10 illustrates an example schematic block diagram of a computing environment with which the subject matter described herein can interact and/or be implemented at least in part, in accordance with one or more embodiments and/or implementations described herein.

### DETAILED DESCRIPTION

### Overview

The technology described herein is generally directed towards a process to reconfigure a radio unit (RU) of a radio system, such as of a cellular system, following reset of the radio unit.

In existing frameworks, reset of a radio unit (RU) can be prone to extended times of service unavailability to user entities (UEs), failed communication between RU and an associated service, management, and orchestration unit (SMO), required employment of the SMO or other higher level (e.g., higher level of a radio system than RU level) software and/or hardware to implement an RU configuration or reconfiguration, etc.

This can be at least partially due to relevant open radio access network (O-RAN) standards only mandating that an RU persist a subset of a configuration in reset-persistent memory, e.g., searchable-mplane-access-vlans-info, certificate, NetConf Access Control Model (NACM) info, synchronization configuration, etc.

Further complicating issues, existing RUs (e.g., hardware and/or software) do not persist even such subset and/or cannot persist even such subset. Moreover, even where an existing RU persists such subset, a higher controller, such as a service management and orchestration unit (SMO) is still employed to reconfigure other mission-critical information, such as power and frequency information, following each RU reset.

In one existing framework, an SMO can reconfigure an RU following reset, with a number of caveats (e.g., deficiencies). With such framework, locking of a cell of a radio system corresponding to the RU will be locked. This involves deleting all UE contexts on the cell and thus causes a service outage relative to that cell for all UEs using that cell and/or attempting to use that cell. If an O1 connection (e.g., communication link) between the SMO and distributed unit (DU) of the radio system is unavailable (e.g., down), service recovery can be impossible until the O1 connection is restored. Further, the O1 connection can often be unreliable, such as where the connection comprises a link established over or via satellite.

Additionally, following each O1 recovery, an SMO first must verify whether an RU reset occurred or not in order to reinitiate the RU configuration. This verification can be complex and can require introduction of non-standard, vendor-specific parameters over an O1 interface. For example, an RU reset/recovery can be achieved through notification of an O-RAN’s recovered-RU-instance-ids remove/add function. When the O1 connection is lost, all notifications are lost. Therefore, when the O1 connection is recovered, the SMO would still have access (e.g., data/metadata visibility of) the presence of the O-RAN’s recovered-RU-instance-ids but would not have access that any one or more notifications of recovered-RU-instance-ids remove/add occurred during the O1 connection interruption time. This can therefore require complex verifications to determine proper parameters and/or configurations for communicating with the RU by the SMO.

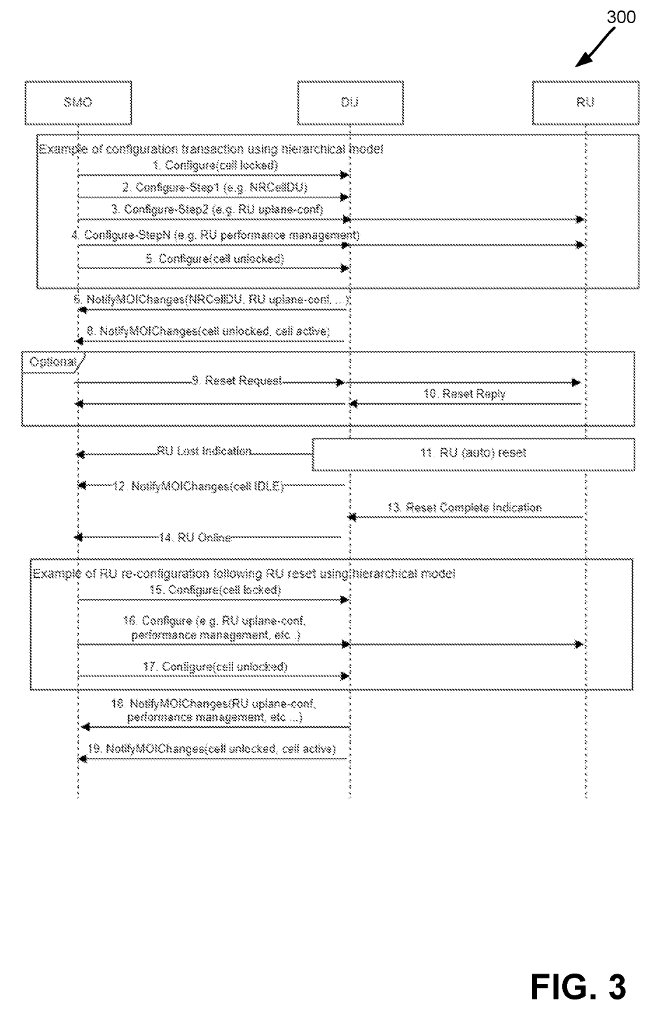

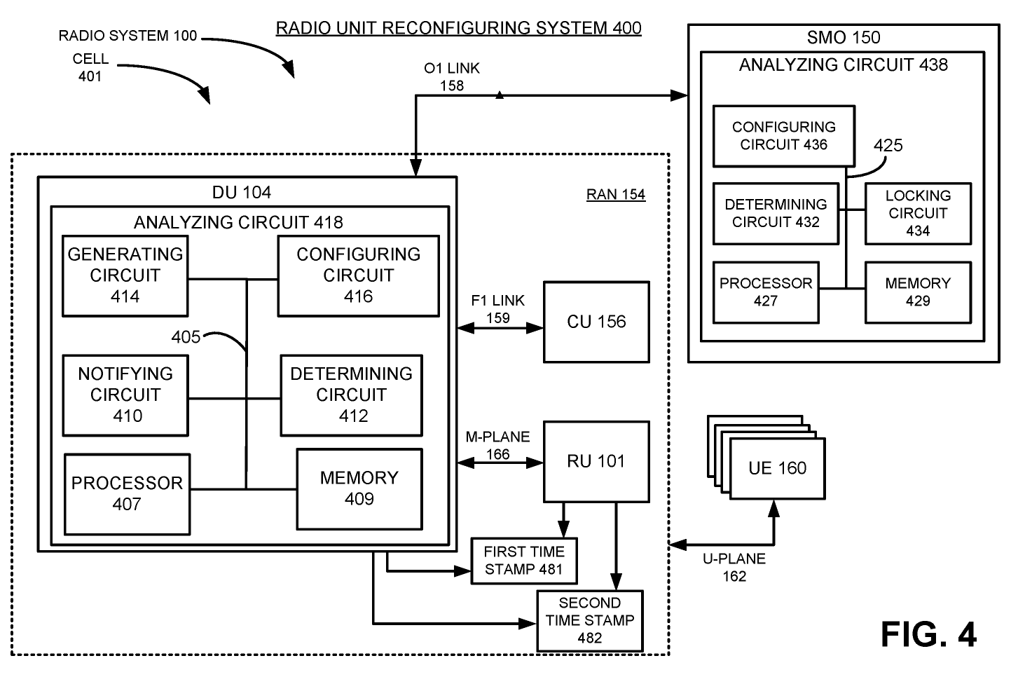

Turning to FIG. 3, illustrated is a reset framework 300 employed by existing frameworks to reconfigure an RU after RU reset. FIG. 3 is non-limiting and is intended to provide background for comprehension of one or more embodiments described herein and described below relative to at least FIGS. 4 - 8.

At the existing reset framework 300, steps 1-5 generally illustrate an example of cell configuration from an SMO to DU/RU using an m-plane hierarchical model. These steps 1-5 can comprise initial configuration of an RU comprising configuring cell locking, RU u-plane configuration, RU performance management and cell unlocking. These steps 1 and 5 can comprise communication between the SMO and DU over the O1 connection to facilitate the cell locking and unlocking. These steps 3 and 4 can comprise communication between the SMO and the RU with the SMO facilitating the configuration of the RU.

Steps 6-8 provide an example of a response confirming the configuration of the RU and subsequent transitioning of a state of the cell (e.g., the cell state) to an active state. At steps 6 and 8, the DU communicates managed object instance (MOI) change notifications regarding the RU u-plane configuration and cell unlock to the SMO based on communication and/or analysis of the RU by the DU.

An RU reset can occur in various ways.

In one or more cases, an RU reset can optionally be triggered from the SMO (e.g., step 9), such as by the SMO communicating to the DU, which then communicates to the RU. Step 11 comprises a reset rely from the RU to the SMO, by way of the DU as an intermediary. In one or more other cases, an RU reset can be auto-triggered by the RU (e.g., step 11). In either case, the reset results in an RU lost indication to SMO by the DU or RU. In O-RAN, this would correspond to notification of a deletion of recovered-RU-instance-ids.

As a result of the RU lost indication, the radio system cell transitions to an IDLE state at step 12 via a communication from the DU to the SMO.

When the RU reset is completed, the RU can send a reset complete indication to the DU (e.g., step 13), and the DU can piggyback the notification to the SMO (e.g., step 14). In O-RAN, this would correspond to notification of new recovered-RU-instance-ids.

Steps 15-17 illustrate an example of the SMO reconfiguring the RU in response to the RU reset. These steps can comprise cell locking by a communication from the SMO to the DU at step 15, RU configuration by way of the SMO communicating through the DU to the RU (e.g., RU u-plane configuration, performance management, etc. at step 16) and subsequent cell unlocking by communication from the SMO to the DU (e.g., step 17).

Steps 18 and 19 provide an example of a response confirming the reconfiguration of the RU and transitioning of the cell state back to ACTIVE. Steps 18 and 19, similar to steps 6 and 8, can comprise the DU communicates MOI change notifications regarding the RU u-plane configuration and cell unlock to the SMO based on communication and/or analysis of the RU by the DU.

Turning now to the one or more novel embodiments discussed herein, to make up for one or more deficiencies of such existing frameworks, proposed is an implementation framework comprising a system, method and/or non-transitory computer-readable medium to reconfigure a radio unit (RU) following RU reset. Different from existing frameworks where an open radio access network (O-RAN) only mandates an RU to persist a small subset of configurations and where upon RU reset a higher radio system layer would be employed to reconfigure the RU again, the one or more embodiments described herein can employ a combination of a service, management, and orchestration unit (SMO) and distributed unit (DU) of a respective radio system to reconfigure the RU. Instead, the reconfiguration using the SMO/DU can generally employ a hierarchical framework of the radio system in an efficient manner, reducing service interruption time and/or enhancing the O-RAN’s reliability by reducing dependencies on the SMO.

That is, the technology described herein can perform such operations in a hardware and/or software accelerated manner using enhanced distributed unit (DU) capabilities to persist RU configuration at and/or by the DU based on minimal input from a service, management, and orchestration unit (SMO) of the associated radio system. As a result, radio system reliability, serviceability, and/or manageability can be better controlled than in existing frameworks for radio systems, with benefits arising for the administrator of the radio system and for user entities (UEs) of the radio system.

These benefits can comprise, but are not limited to, shortening UE disconnection due to RU reset. In instances of lost O1 connection between the SMO and DU, the DU can still persist the configuration of the RU with limited cell/RU service lost for UEs. Another benefit can comprise lack of reliance on the O1 connection, which as noted above, can be unreliable. That is, even if an O1 connection is down, RU reconfiguration/configuration can proceed via the DU. Further, timestamps can be employed by the one or more novel embodiments described herein, allowing for the DU to verify if the RU has been additionally reset or recovered. That is, blind configuration/reconfiguration of the RU can be avoided.

Additionally, in one or more embodiments, SMO/DU implementation can comprise backward compatibility for legacy behavior. Such legacy behavior can comprise configuring an RU using an SMO, without using the DU functionality described relative to the one or more novel embodiments described herein. This can be employed such as where an SMO is unable to function relative to the novel DU functionality described herein.

Put another way, a method described herein for auto configuring an RU can comprise various functionalities that are not provided, and which cannot be provided, by existing RU configuration frameworks.

A first functionality can comprise an RU-configuration-persistent functionality at the DU. That is, the O-RAN’s DU functionality can be enhanced to indicate that DU can persist RU configuration absent configuration by the SMO using the DU as an intermediary. This functionality can be used to indicate to the SMO that the DU can operate in a simpler mode (e.g., simpler than existing frameworks) where the DU controls RU reconfiguration following RU reset.

A second functionality can comprise an efficient implementation of RU auto-configuration at/by the DU. That is, the O-RAN’s DU configuration can be enhanced to support an RU Reconfiguration mode, which can either be DU-driven, according to the one or more novel aspects described herein, or SMO-driven. SMO-driven is for legacy operation, and the new DU-driven is for operation where DU persists the full RU configuration information. In the DU-driven mode, when a given RU is re-discovered by the same DU, the DU proceeds with RU reconfiguration. The DU can connect to one or more RUs of one or more different cells of a radio system, managing the RU’s independently.

A third functionality can comprise an efficient implementation of RU auto-configuration at the SMO. That is, based on a combination of an RU functionality, DU functionality and SMO functionality, the SMO can make a determination as to proceed with an optimum configuration method. In the target case where the RU does not persist the configuration and the DU has the RU-configuration-persistent capability, the SMO can switch to the simpler mode operation (e.g., DU-driven) and no longer perform cell reset to reconfigure the RU as per a legacy mode (e.g., SMO-driven as in existing frameworks).

To provide these one or more operations and/or features, reference throughout this specification to “one embodiment,” “an embodiment,” “one implementation,” “an implementation,” etc. means that a particular feature, structure, or characteristic described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, or characteristics may be combined in any suitable manner in one or more embodiments/implementations.

As used herein, the term “configuration” can also refer to reconfiguration, and vice versa, the term “reconfiguration” can refer to “configuration.” That is, processes, aspects, information, functions, etc. described below relative to an RU configuration or an RU reconfiguration can equally apply to either of an RU configuration or RU reconfiguration unless otherwise indicated.

As used herein, the term “cost” can refer to power, money, memory, processing power, thermal power, size, weight and/or the like.

As used herein, the term “entity” can refer to a machine, device, smart device, component, hardware, software and/or human.

As used herein, with respect to any aforementioned and below mentioned uses, the term “in response to” can refer to any one or more states including, but not limited to: at the same time as, at least partially in parallel with, at least partially subsequent to and/or fully subsequent to, where suitable.

As used herein, the term “resource” can refer to power, money, memory, processing power and/or the like.

### Example Radio System Architectures

One or more embodiments are now described with reference to the drawings, where like referenced numerals are used to refer to like elements throughout. In the following description, for purposes of explanation, numerous specific details are set forth to provide a more thorough understanding of the one or more embodiments. It is evident, however, in various cases, that the one or more embodiments can be practiced without these specific details.

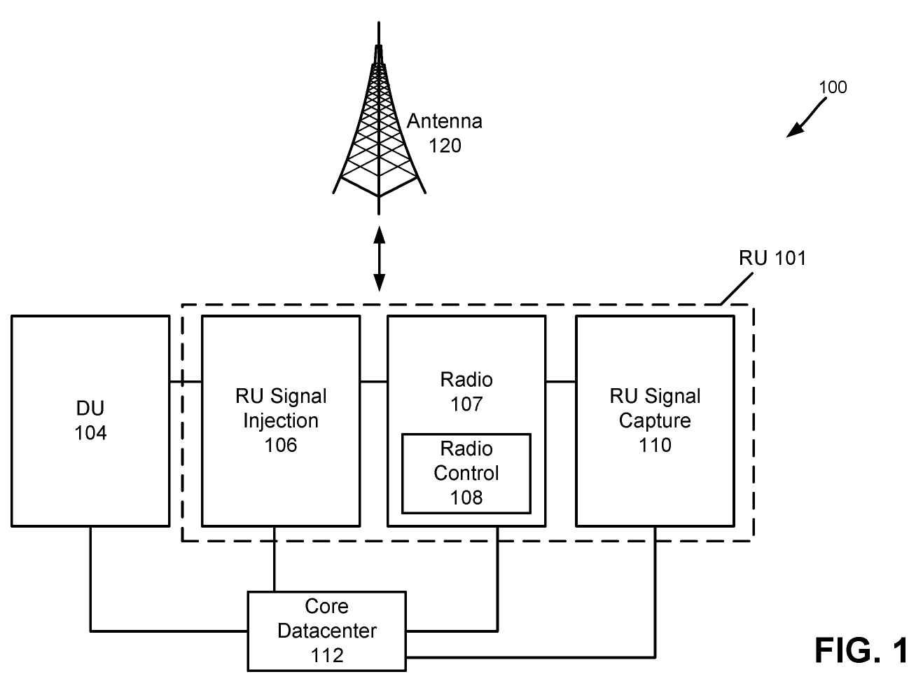

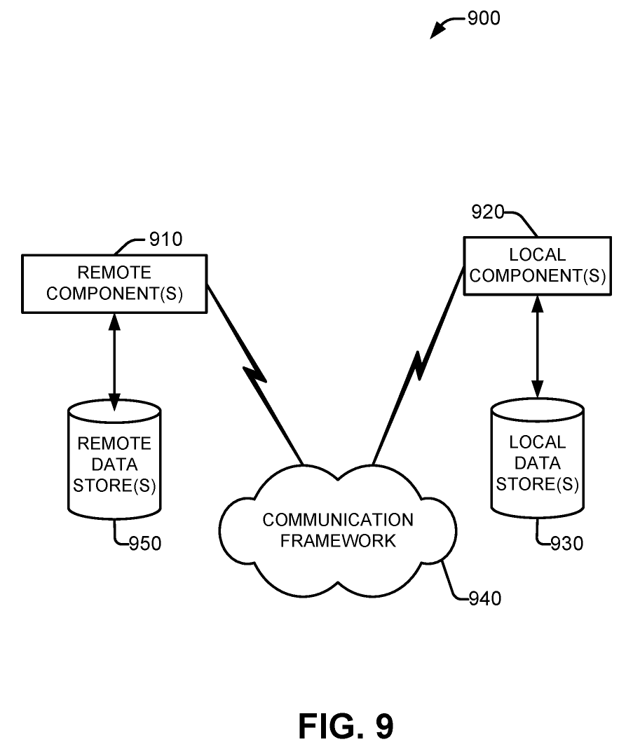

Further, the embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting system architecture 100 as illustrated at FIG. 1, and/or systems thereof, can further comprise one or more computer and/or computing-based elements described herein with reference to an operating environment, such as the operating environment 900 illustrated at FIG. 9. In one or more described embodiments, computer and/or computing-based elements can be used in connection with implementing one or more of the systems, devices, components and/or computer-implemented operations shown and/or described in connection with FIG. 1 and/or with other figures described herein.

Turning to FIG. 1, a high-level radio system architecture is illustrated at 100. The radio system 100 can comprise a distributed unit (DU) signal injection portion 104 (also herein referred to as a DU portion 104 or DU 104) and a radio unit (RU) 101. The RU 101 can comprise a radio unit (RU) signal injection portion 106 (also herein referred to as an RU signal injection portion 106), the radio control 108, and an RU signal capture portion 110. Generally, the DU 104 can provide both baseband processing and RF functions. The RU signal capture portion 110 can obtain signals from a respective antenna 120 and convert the RF signal into a data signal, and vice versa. The RU signal capture portion 110 can have one or more statistical counters, accumulators, counter circuits and/or the like.

In one or more embodiments, the radio control 108, in view of information received from the RU signal capture portion 110, can place an order for service, maintenance, hardware and/or firmware to a core data center 112. In one or more embodiments, the radio control 108, in view of information received from the RU signal capture portion 110, can at least partially autonomously request or request and receive one or more software, firmware and/or other system updates. Together, the DU 104 and RU portion 106 can provide data to, and receive data from, the core datacenter 112.

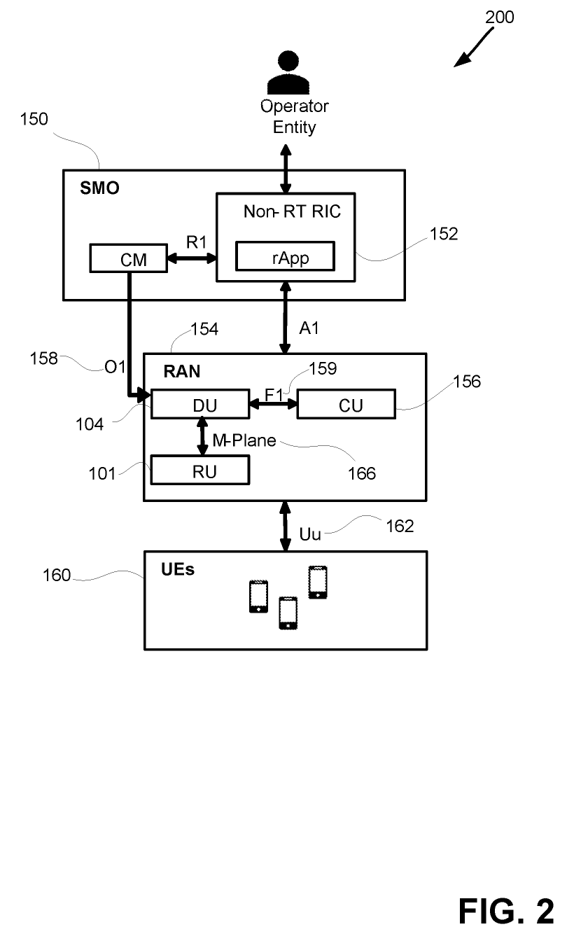

Looking next to FIG. 2, illustrated is another schematic of the radio system 100 that can be at least partially managed for control of RU configuration and/or reconfiguration. A radio access network (RAN) 154 can comprise a distributed unit (DU) 104, radio unit (101), and centralized unit (CU) 156. User entities (UEs) 160 access the RAN by a user plane (Uu) 162 to obtain service.

As illustrated, a service, management, and orchestration unit (SMO) 150 and a non-real-time RAN—intelligent-controller (non-RT RIC) 152 can serve as configuring entities of a radio unit (RU) 101, via the configuring distributed unit (DU) 104. A DU network function (NF) of the DU 104 can serve as an RU controller, at least in the illustrated m-plane (166) hierarchical model, for purposes of configuration.

The O1 link 158 provides an ORAN interface between the SMO 150 and CU/DU. The F1 link 159 provides a RAN interface between the DU 104 and the CU 156.

Cell configuration can comprise configuration under the CU 156, DU 104, and dedicated part of the RU 104 (e.g., a section of o-ran-uplane-config).

RU configuration can comprise both common RU and dedicated RU configurations. The common RU can comprise configuration common across cells on the same RU 101. Accordingly, one or more radio cells can employ a same RU 101. One or more RUs 101 can be managed by a same DU 104.

Turning now to FIG. 4, an example of a radio unit configuration system is illustrated at 400, with description being provided below. The radio unit configuration system 400 is part of the radio system 100 (e.g., of FIGS. 1 and/or 2) and comprises aspects of the radio system 100 as described at FIG. 2. The radio unit configuration system 400 is described as a system for purposes here of explanation, however, the radio unit configuration system 400 can be considered a subsystem of a radio system 100. For purposes of brevity, various aspects of the radio system 100 (e.g., as illustrated at FIG. 1) are not illustrated at FIG. 4. While referring here to one or more processes, operations, facilitations and/or uses of the non-limiting system architecture 400, description provided herein, both above and below, also can be relevant to one or more other non-limiting system architectures described herein.

Generally, the radio unit configuration system 400 can control configuration of an RU 101 after reset of the RU 101. As illustrated at FIG. 4, the radio system 100 (comprising the radio unit configuration system 400) can employ m-plane hierarchical model operation.

Generally, the radio data analysis system 400 can comprise any suitable computing devices, hardware, software, operating systems, drivers, network interfaces, and/or so forth. However, for purposes of brevity, only components generally relevant to time domain power data detection, collection, and/or analysis are illustrated in FIG. 2. As illustrated, the DU 104 and RU 101 of the RAN 154, along with the SMO 150 each can facilitate configuration of the RU 101. Note that in one or more embodiments, more than one RU 101 can be controlled by the DU 104 for persisting their configurations.

As illustrated, the DU 104 can comprise various elements, which need not be physically separate elements, but are described separately herein for the purposes of identifying functions of the DU in the novel one or more embodiments described herein.

For example, the DU 104 can comprise a processor 407, memory, 409, bus 405, notifying circuit 410, determining circuit 412, generating circuit 414 and/or configuring circuit 416.

Discussion first turns to the processor 407, memory 409, and bus 405 of the radio unit configuration system 400.

In one or more embodiments, the DU 104 can comprise the processor 407 (e.g., computer processing unit, microprocessor, classical processor and/or like processor). In one or more embodiments, an element associated with DU 104, as described herein with or without reference to the one or more figures of the one or more embodiments, can comprise one or more computer and/or machine readable, writable and/or executable components and/or instructions that can be executed by processor 407 to facilitate performance of one or more processes defined by such component(s) and/or instruction(s). In one or more embodiments, the processor 407 can comprise the notifying circuit 410, determining circuit 412, generating circuit 414 and/or configuring circuit 416.

The processor 407 can be configured to control one or more components/elements of the radio unit DU 104, such as the notifying circuit 410, determining circuit 412, generating circuit 414 and/or configuring circuit 416. That is, the processor 407 can be configured to control configuration of the radio unit 101.

In one or more embodiments, the DU 104 can comprise the machine-readable memory 409 that can be operably connected to the processor 407. The memory 409 can store computer-executable instructions that, upon execution by the processor 407, can cause the processor 407 and/or one or more other components of the radio unit configuration system 400 (e.g., notifying circuit 410, determining circuit 412, generating circuit 414 and/or configuring circuit 416) to perform one or more actions. In one or more embodiments, the memory 409 can store one or more computer-executable components.

The DU 104 and/or elements thereof as described herein, can be communicatively, electrically, operatively, optically and/or otherwise coupled to one another via a bus 405 to perform functions of the DU 104 and/or one or more elements thereof and/or coupled therewith. Bus 405 can comprise one or more of a memory bus, memory controller, peripheral bus, external bus, local bus and/or another type of bus that can employ one or more bus architectures. One or more of these examples of bus 405 can be employed to implement one or more embodiments described herein.

It is noted that in one or more example embodiments, the notifying circuit 410, determining circuit 412, generating circuit 414 and/or configuring circuit 416 can be implemented independently, without one or more other of the notifying circuit 410, determining circuit 412, generating circuit 414 and/or configuring circuit 416. Additionally and/or alternatively, the notifying circuit 410, determining circuit 412, generating circuit 414 and/or configuring circuit 416 can be comprised by a high-level analyzing component 438, one or more of the below-described functions of the notifying circuit 410, determining circuit 412, generating circuit 414 and/or configuring circuit 416 can be performed by the high-level analyzing component 438, and/or notifying circuit 410, determining circuit 412, generating circuit 414 and/or configuring circuit 416 can be omitted with the high-level analyzing component 438 performing one or more of the below-described functions of the one or more omitted notifying circuit 410, determining circuit 412, generating circuit 414 and/or configuring circuit 416.

As illustrated, the SMO 150 can comprise various elements, which need not be physically separate elements, but are described separately herein for the purposes of identifying functions of the DU in the novel one or more embodiments described herein.

For example, the SMO 150 can comprise a processor 427, memory, 429, bus 425, determining circuit 432, locking circuit 434 and/or configuring circuit 436.

Discussion turns to the processor 427, memory 429, and bus 425 of the radio unit configuration system 400.

In one or more embodiments, the SMO 150 can comprise the processor 427 (e.g., computer processing unit, microprocessor, classical processor and/or like processor). In one or more embodiments, an element associated with SMO 150, as described herein with or without reference to the one or more figures of the one or more embodiments, can comprise one or more computer and/or machine readable, writable and/or executable components and/or instructions that can be executed by processor 427 to facilitate performance of one or more processes defined by such component(s) and/or instruction(s). In one or more embodiments, the processor 427 can comprise the determining circuit 432, locking circuit 434 and/or configuring circuit 436.

The processor 427 can be configured to control one or more components/elements of the radio unit SMO 150, such as the determining circuit 432, locking circuit 434 and/or configuring circuit 436. That is, the processor 427 can be configured to aid configuration of the radio unit 101, at least in determining whether to proceed in an SMO-driven or DU-driven manner.

In one or more embodiments, the SMO 150 can comprise the machine-readable memory 429 that can be operably connected to the processor 427. The memory 429 can store computer-executable instructions that, upon execution by the processor 427, can cause the processor 427 and/or one or more other components of the SMO 150 (e.g., determining circuit 432, locking circuit 434 and/or configuring circuit 436) to perform one or more actions. In one or more embodiments, the memory 429 can store one or more computer-executable components.

The SMO 150 and/or elements thereof as described herein, can be communicatively, electrically, operatively, optically and/or otherwise coupled to one another via a bus 425 to perform functions of the SMO 150 and/or one or more elements thereof and/or coupled therewith. Bus 425 can comprise one or more of a memory bus, memory controller, peripheral bus, external bus, local bus and/or another type of bus that can employ one or more bus architectures. One or more of these examples of bus 425 can be employed to implement one or more embodiments described herein.

It is noted that in one or more example embodiments, the determining circuit 432, locking circuit 434 and/or configuring circuit 436 can be implemented independently, without one or more other of the determining circuit 432, locking circuit 434 and/or configuring circuit 436. Additionally and/or alternatively, the determining circuit 432, locking circuit 434 and/or configuring circuit 436 can be comprised by a high-level analyzing component 438, one or more of the below-described functions of the determining circuit 432, locking circuit 434 and/or configuring circuit 436 can be performed by the high-level analyzing component 438, and/or determining circuit 432, locking circuit 434 and/or configuring circuit 436 can be omitted with the high-level analyzing component 438 performing one or more of the below-described functions of the one or more omitted determining circuit 432, locking circuit 434 and/or configuring circuit 436.

In one or more embodiments, the radio unit configuration system 400 can be coupled (e.g., communicatively, electrically, operatively, optically and/or like function) to one or more external systems (e.g., a system management application), sources and/or devices (e.g., classical communication devices and/or like devices), such as via a network. In one or more embodiments, one or more of the components of the non-limiting system architecture of the radio unit configuration system 400 can reside in the cloud, and/or can reside locally in a local computing environment (e.g., at a specified location(s)).

In addition to the bus 405, processor 407, memory 409, bus 425, processor 427 and/or memory 429 described above, the radio unit configuration system 400 can comprise one or more computer and/or machine readable, writable and/or executable components and/or instructions that, when executed by processor 407 and/or processor 427, can facilitate performance of one or more operations defined by such component(s) and/or instruction(s).

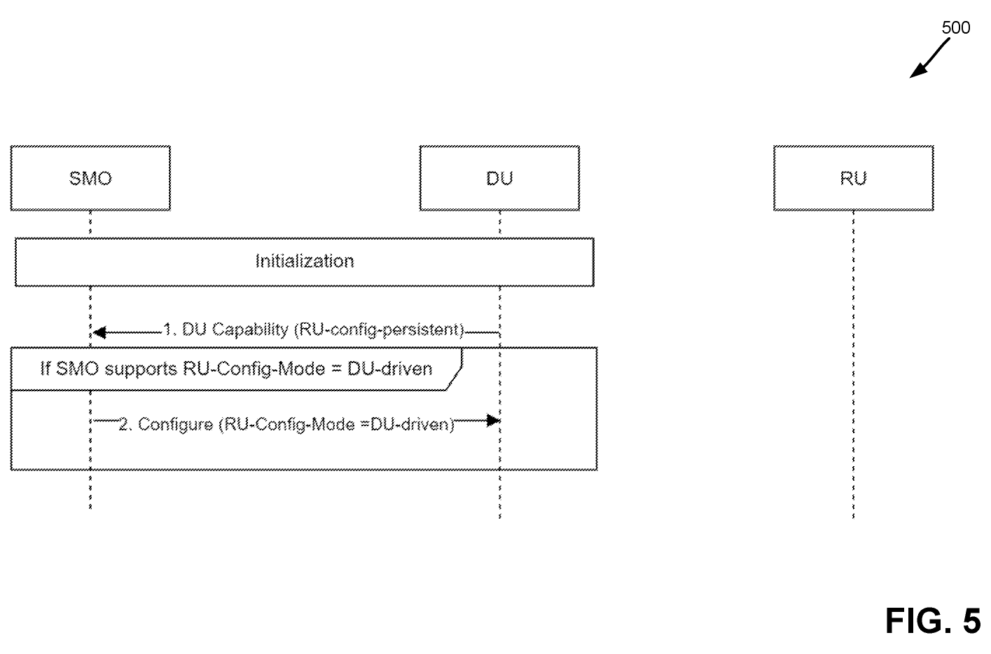

For example, turning now to FIG. 5, but still referring to FIG. 4, discussed are a first set of processes that can be employed by the radio unit reconfiguring system 400 for initializing functionalities between the SMO 150 and the DU 104. That is, at step 1 of FIG. 4, the DU 104 (e.g., the notifying circuit 410) can generate a notification to the SMO 150, or otherwise communicate with the SMO 150, information (e.g., data/metadata) regarding the DU’s functionalities. That is the DU 104 can notify the SMO 150 that the DU can persist reconfiguration/configuration of RU’s 101 of the cell 401 in a DU-driven RU-configuration mode.

To allow for this DU-driven mode, the DU can comprise circuits, software and/or hardware allowing for persisting of some and/or all configurations for one or more RU’s 101. Put another way, the DU capability is enhanced to provide RU-config-persistent capability and notification of such capability to the SMO 150. This can particularly be the case for m-plane hierarchical model operation of a radio system, such as the radio system 100.

In one or more cases, the radio system 100 can be a 5G cellular system, O-RAN/3GPP system, etc.

In response to receipt of the RU-config-persistent notification (e.g., FIG. 4, step 1), the SMO 150 (e.g., determining circuit 432) can communicate (e.g., confirm) to the DU 104 that the DU 104 can proceed in a DU-driven RU-configuration mode in case of future RU resets. It is noted that this back and forth initialization between the DU 104 and the SMO 150 can occur prior to an RU reset or in response to an RU reset.

It also is noted that the SMO 150 can have two cases for which the SMO 150 can make a determination (e.g., via the determining circuit 432). In a first case, the SMO 150 can be incapable of allowing the DU to persist configuration of RUs. In a second case, the SMO can leverage the DU to operate in the DU-driven mode. If, for some reason, whether software-related, hardware-related, troubleshooting, defect, O1 issues, etc., the SMO cannot or is default to not leverage a DU-driven mode, the SMO can instead fail the initialization of FIG. 5 by notifying the DU 104 that the cell will proceed in an SMO-driven default mode for RU configurations. This SMO-driven mode can be referred to as an existing mode and/or a legacy mode.

On the other hand, in the DU-driven mode, the SMO 160 (e.g., configuring circuit 436) can configure the DU 104 (FIG. 5, step 2) to persist a partial and/or full RU configuration for one or more RUs 101 of the radio system cell 401.

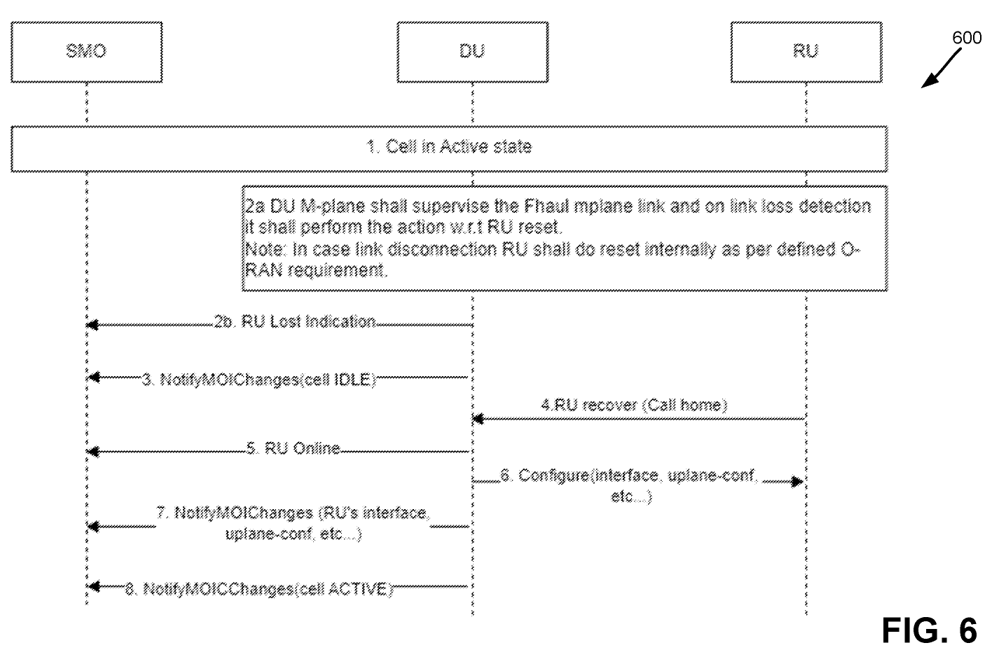

Turning next to FIG. 6, illustrated are a second set of processes for reconfiguring or configuring an RU 101, in a DU-driven mode (e.g., after initialization of the DU-driven mode by the SMO 150 and DU 104), in response to an RU reset. In one or more cases, such RU reset can be triggered by the RU 101. In one or more other cases, a configuration or reconfiguration of the RU 101 can be triggered by the DU 104 and/or SMO 150.

Initially, the radio system cell 401 is in ACTIVE state. In one or more cases, this ACTIVE state can be, for example, a state after completing steps 1-8 of FIG. 3 for initial configuration of the RU 101.

At step 2a of FIG. 6, the DU 104 (e.g., determining circuit 412) can determine that an RU reset has occurred. For example, the DU 104 (e.g., determining circuit 412) can detect an RU reset, such as based on a determination of a lost FH link connection (e.g., over the M-plane 166). In response thereto, the DU 104 can generate (e.g., generating circuit 414) and send (e.g., notifying circuit 410) a notification to the SMO 160 that RU connection has been lost (e.g., FIG. 6, step 2). In O-RAN, this can correspond to recovered-RU-instance-ids delete indication.

Subsequently, the cell 401 transitions to IDLE state (e.g., FIG. 6, step 3), either by default and/or by notification by the DU 104 (e.g., notifying circuit 410) to the SMO 150 of MOI changes.

It is noted that the cell 401 can transition to the IDLE state even if the notification from the DU 104 to the SMO 160 regarding RU reset is not completed. For example, the O1 connection 158 can be down, preventing receipt of the notification by the SMO 150. Different from legacy modes, SMO-driven modes, and/or existing frameworks, the one or more embodiments described herein can still proceed with DU-driven RU configuration in view of the initialization of the DU-driven mode and DU configuration by the SMO 150 (e.g., FIG. 5, step 2).

At FIG. 6, step 4, when the RU reset is completed, the RU 101 can perform a call home function to the DU 104 via the M-plane 166. At step 5, the DU 104 can generate 104 (e.g., generating circuit 414) and send (e.g., notifying circuit 410) a notification to the SMO 160 that RU 101 connection has been recovered and is back online.

Turning next to steps 6 to 8, reconfiguration of the RU 101 can be facilitated by the DU 104 (e.g., configuring circuit 416) in the DU-driven mode.

That is, as the DU 104 can recognize the RU 101 from configurations stored by the DU 104 (e.g., stored recovered-RU-instance-id), the DU 104 can proceed with RU re-configuration (e.g., FIG. 6, step 6). At step 7 of FIG. 6, the DU 104 can generate 104 (e.g., generating circuit 414) and send (e.g., notifying circuit 410) a notification to the SMO 160 with information (e.g., data and/or metadata) defining the updated RU’s state of configuration (e.g., reconfiguration).

Eventually, the cell 401 transitions back to the ACTIVE state (FIG. 6, step 8).

Regarding the DU-driven mode, there are a number of benefits that are realized as practical applications of the DU-driven mode. These practical applications and benefits are not possible in the legacy m ode, SMO-driven mode, and/or existing frameworks for RU configuration.

A first practical application is that in DU-driven mode, the SMO 150 does not proceed with locking (e.g., by the locking circuit 434) of the radio system cell 401. That is, in DU-driven mode, the SMO 150 has established a protocol with the DU 104 cell lockout after reconfiguring of the RU 101 can be shortened as compared to existing frameworks. That is, service disruption to UEs 160 is minimized, reduced, etc., as compared to existing frameworks (e.g., SMO-driven) for RU configuration.

In one or more cases, if SMO 150 detects that the RU 101 is on a different DU 104 (e.g., relative to FIG. 6, step 7), the SMO 150 can execute one or more nominal recovery actions. This can comprise cleaning up the existing cell 401 from old DU 104, and configuring the full cell 401 from scratch on the new DU 104, which processes/steps are not shown at FIG. 6.

A second practical application is that FIG. 6, steps 7 and 8 comprise mere notifications. That is, in a nominal recovery case, even if the O1 link 158 is bad, the cell data path (e.g., over the U-plane 162) will be restored and traffic will resume between UEs and the RAN 154 again (e.g., between UEs and 5GC).

A third practical application is that prior to reconfiguring the RU 101 by the DU 104, the DU 104 can compare a first time stamp 481 (e.g., corresponding to the RU 101) associated with the detecting that the RU 101 has been reset with a second time stamp 482 (e.g., also corresponding to the RU 101, but to a different reset configuration of the RU 101 that corresponding to the first time stamp 481) associated with a current state of the RU 101. That is, the second time stamp 482 can be associated with point in time after generation of the first time stamp 481.

In one or more cases, in response to the DU 104 determining (e.g., determining circuit 412) that the first time stamp 481 and the second time stamp 482 do not match, the DU 104 can determine (e.g., determining circuit 412) to reconfigure the RU 101 based on a second parameter of the RU 101 that is associated with the second time stamp 482, in place of a first parameter of the RU 101 that is associated with the first time stamp 481.

As a benefit, this capability of the DU 104 can avoid improper configuration of the RU 101 by the DU 104 (e.g., configuring circuit 416), in view of an additional reset of the RU 101 that occurred after the initial reset (e.g., FIG. 6, step 2b) that triggered the DU-driven RU reconfiguration.

It is noted that the SMO 150 cannot perform this operation and thus in an SMO-driven case (e.g., existing frameworks), the SMO can reconfigure the RU relative to an improper parameter and/or configuration due to additional RU resets that may have occurred (e.g., such as while the O1 link 158 was down). That is, in a case where the O1 link 158 is down, the SMO 150 does not receive RU reset notifications from the DU 104.

In one or more embodiments, a group of radio unit configuration systems 400 can be provided at a radio system (e.g., radio system 100). Each radio unit configuration system 400 of the group of systems can be configured to function relative to one or more different cells of the radio system 100. Any one radio unit configuration system 400 can control configuration of one or more radio units (RUs). Different radio unit configuration systems 400 of the group of systems can control configuration of different RUs.

### Additional Example Radio System Description

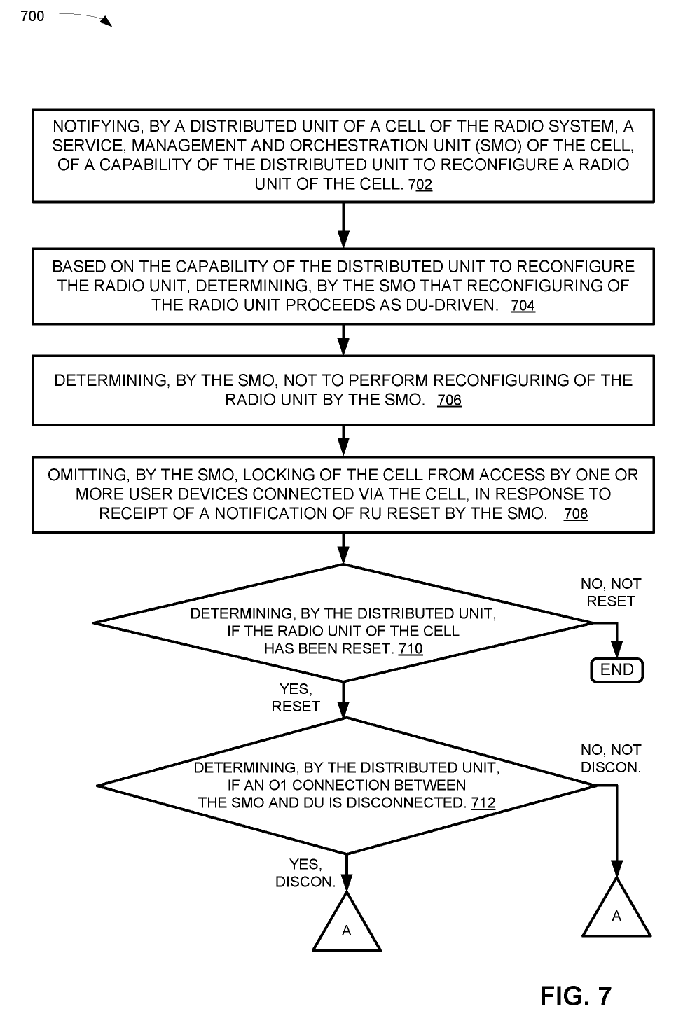

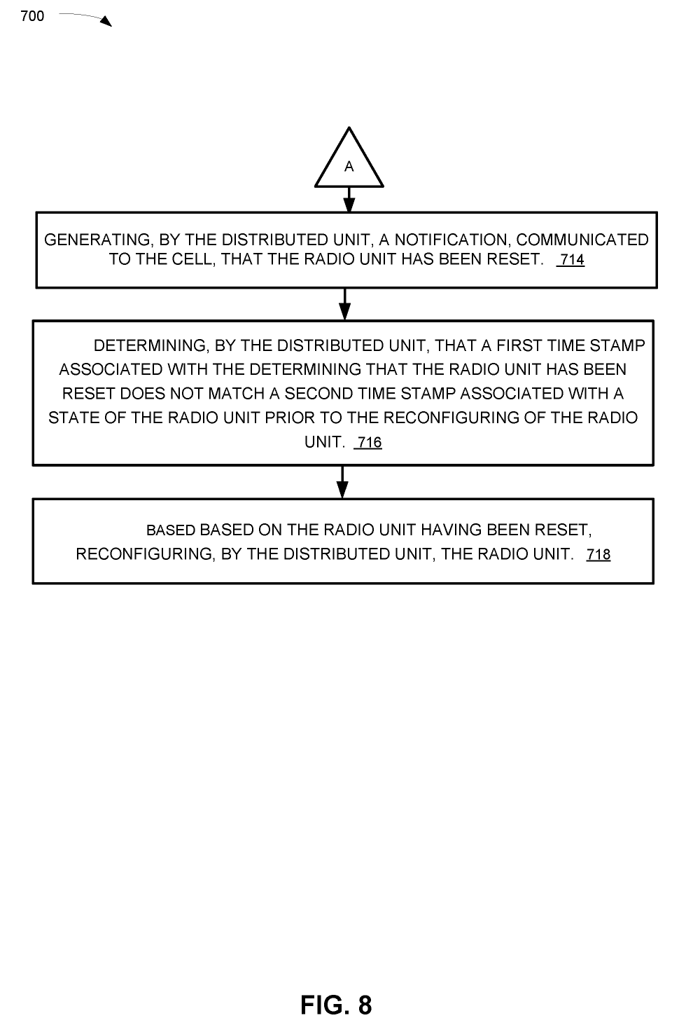

Turning now to FIGS. 7 and 8, a process flow comprising a set of operations is illustrated relative to FIGS. 4-6 for configuration/reconfiguration of a radio unit (RU) with a DU persisting the configuration, as opposed to an SMO. One or more elements, objects and/or components referenced in the process flow 700 can be those of system 100, system 200, and/or system 400. Repetitive description of like elements and/or processes employed in respective embodiments is omitted for sake of brevity.

At operation 702, the process flow 700 can comprise notifying (e.g. FIG. 5, step 1), by a distributed unit (e.g., DU 104) of a cell (cell 401) of a radio system (e.g., radio system 100), a service, management and orchestration unit (e.g., SMO 150) of the cell, of a capability of the distributed unit to reconfigure a radio unit (e.g., RU 101) of the cell.

At operation 704, the process flow 700 can comprise, based on the capability of the distributed unit to reconfigure the radio unit, determining, by the SMO that reconfiguring of the radio unit proceeds as DU-driven (e.g., FIG. 5, step 2).

At operation 706, the process flow 700 can comprise determining, by the SMO, not to perform reconfiguring of the radio unit by the SMO.

At operation 708, the process flow 700 can comprise omitting, by the SMO, locking of the cell from access by one or more user devices (e.g., user entities 160) connected via the cell, in response to receipt of a notification (e.g., FIG. 6, step 2b) of RU reset by the SMO.

At operation 710, the process flow 700 can comprise determining, by the distributed unit, if the radio unit of the cell has been reset. If yes, the process flow 700 can proceed to operation 712. If not, the process flow 700 can proceed to end or to continue monitoring the radio unit.

At operation 712, the process flow 700 can comprise determining, by the distributed unit, if an O1 connection (e.g., O1 link 158) between the SMO and the distributed unit is disconnected. In either case of yes or no, the process flow 700 can proceed to operation 714. That is, disconnection of the O1 link does not prevent reconfiguring of the RU, whereas disconnection of the O1 link can prevent legacy and existing frameworks from reconfiguring the RU (e.g., where the SMO persists the reconfiguration).

At operation 714, the process flow 700 can comprise generating, by the distributed unit, a notification (e.g., FIG. 6, step 5), communicated to the cell, that the radio unit has been reset.

At operation 716, the process flow 700 can comprise determining, by the distributed unit, that a first time stamp (e.g., first time stamp 481) associated with the determining that the radio unit has been reset does not match a second time stamp (e.g., second time stamp 482) associated with a state of the radio unit prior to the reconfiguring of the radio unit.

At operation 718, the process flow 700 can comprise, based on the radio unit having been reset, reconfiguring, by the distributed unit, the radio unit (e.g., FIG. 6, step 6).

For simplicity of explanation, the computer-implemented methodologies and/or processes provided herein are depicted and/or described as a series of acts. The subject innovation is not limited by the acts illustrated and/or by the order of acts, for example acts can occur in one or more orders and/or concurrently, and with other acts not presented and described herein. The operations of process flows of diagrams 1100 are example operations, and there can be one or more embodiments that implement more or fewer operations than are depicted.

Furthermore, not all illustrated acts can be utilized to implement the computer-implemented methodologies in accordance with the described subject matter. In addition, the computer-implemented methodologies could alternatively be represented as a series of interrelated states via a state diagram or events. Additionally, the computer-implemented methodologies described hereinafter and throughout this specification are capable of being stored on an article of manufacture to facilitate transporting and transferring the computer-implemented methodologies to computers. The term article of manufacture, as used herein, is intended to encompass a computer program accessible from any machine-readable device or storage media.

In summary, described herein can reconfigure a radio unit (RU) 101 of a radio system 100 following RU reset. An example radio system 100 can comprise a distributed unit 104 of a cell 401 of the radio system 100, the distributed unit 104 comprising at least one processor 407 and at least one memory 409 communicatively coupled to the at least one processor 407, and a radio unit 101 of the cell 401, wherein the distributed unit 104 detects that the radio unit 101 has been reset, and wherein the distributed unit 104, in response to detecting that the radio unit 101 has been reset, reconfigures the radio unit 101.

As a result, a method can be provided to persist configuration of an RU using a DU of the cell, as opposed to persisting the configuration with the SMO. Practical applications of one or more of the processes performed herein by the one or more embodiments described herein comprise allowing for reduced locking of the cell, reduced and/or eliminated service loss to UEs, and/or non-reliance on the O1 connection.

Another practical application can comprise an efficient implementation of RU auto-configuration at the SMO. That is, based on a combination of an RU functionality, DU functionality and SMO functionality, the SMO can make a determination as to proceed with an optimum configuration method. In the target case where the RU does not persist the configuration and the DU has the RU-configuration-persistent capability, the SMO can switch to the simpler mode operation (e.g., DU-driven) and no longer perform cell reset to reconfigure the RU as per a legacy mode (e.g., SMO-driven as in existing frameworks).

Still another practical application can comprise an efficient implementation of RU auto-configuration at/by the DU. That is, the O-RAN’s DU configuration can be enhanced to support an RU Reconfiguration mode, which can either be DU-driven, according to the one or more novel aspects described herein, or SMO-driven. SMO-driven is for legacy operation, and the new DU-driven is for operation where DU persists the full RU configuration information. In the DU-driven mode, when a given RU is re-discovered by the same DU, the DU proceeds with RU reconfiguration. The DU can manage one or more RUs of one or more different cells of a radio system.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein are inherently and/or inextricably tied to computer technology and cannot be implemented outside of a computing environment. For example, one or more processes performed by one or more embodiments described herein can more efficiently, and even more feasibly, provide RU configuration in an O1-free manner, UE lockout-reduced manner, and/or service-loss-reduced manner, as compared to existing systems and/or techniques. Systems, computer-implemented methods and/or computer program products facilitating performance of these processes are of great utility in the field radio system management and cannot be equally practicably implemented in a sensible way outside of a computing environment.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively communicate over various radio communication links (e.g., F1 link, O1 link, M-plane, U-plane, etc.) to control functionalities amongst elements of a radio cell, including an RU, DU, CU and/or SMO. And, neither can the human mind nor a human with pen and paper electronically perform such processes as conducted by one or more embodiments described herein.

In one or more embodiments, one or more of the processes described herein can be performed by one or more specialized computers (e.g., a specialized processing unit, a specialized classical computer, and/or another type of specialized computer) to execute defined tasks related to the one or more technologies described above. One or more embodiments described herein and/or components thereof can be employed to solve new problems that arise through advancements in technologies mentioned above, employment of cloud computing systems, computer architecture and/or another technology.

One or more embodiments described herein can be fully operational towards performing one or more other functions (e.g., fully powered on, fully executed and/or another function) while also performing the one or more operations described herein.

The paragraphs that follow provide additional summaries describing example devices, systems, methods and/or non-transitory mediums.

An example radio system can comprise a distributed unit of a cell of the radio system, the distributed unit comprising at least one processor and at least one memory communicatively coupled to the at least one processor, and a radio unit of the cell, wherein the distributed unit detects that the radio unit has been reset, and wherein the distributed unit, in response to detecting that the radio unit has been reset, reconfigures the radio unit.

The radio system of any preceding paragraph can comprise a service, management and orchestration unit (SMO) of the cell, wherein the distributed unit notifies the SMO that the radio unit has been reset, and wherein the SMO omits locking of the cell in connection with being notified by the distributed unit.

The radio system of any preceding paragraph can comprise a service, management and orchestration unit (SMO) of the cell, wherein the distributed unit notifies the SMO that the radio unit has been reset, wherein the SMO determines that the distributed unit is able to proceed with reconfiguring the radio unit or that the SMO is able to proceed with the reconfiguring of the radio unit, and wherein the SMO notifies the distributed unit that the distributed unit has been determined to be able to proceed with the reconfiguring of the radio unit or that the SMO has been determined to be able to proceed with the reconfiguring of the radio unit.

The radio system of any preceding paragraph can comprise a service, management and orchestration unit (SMO) of the cell, wherein the distributed unit notifies the SMO that the radio unit has been reconfigured.

The radio system of any preceding paragraph can comprise a service, management and orchestration unit (SMO) of the cell, wherein the distributed unit notifies the SMO of a capability of the distributed unit to reconfigure the radio unit, and wherein the SMO confirms the capability of the distributed unit to the distributed unit.

The radio system of any preceding paragraph can comprise wherein the distributed unit proceeds with reconfiguring the radio unit in response to the detecting that the radio unit has been reset.

The radio system of any preceding paragraph can comprise a service, management and orchestration unit (SMO) of the cell, wherein the distributed unit attempts to notify the SMO that the radio unit has been reset, and wherein, in response to determining that an O1 connection between the SMO and the distributed unit is disconnected, the distributed unit proceeds with reconfiguring the radio unit.

The radio system of any preceding paragraph can comprise wherein the radio unit is again reset after the distributed unit detects that the radio unit has been reset, and wherein the distributed unit, prior to reconfiguring the radio unit, compares a first time stamp associated with the detecting that the radio unit has been reset with a second time stamp associated with a current state of the radio unit.

The radio system of any preceding paragraph can comprise wherein, in response to the distributed unit determining that the first time stamp and the second time stamp do not match, the distributed unit determines to reconfigure the radio unit based on a second parameter of the radio unit that is associated with the second time stamp, in place of a first parameter of the radio unit that is associated with the first time stamp.

Another example radio system can comprise a distributed unit of a cell of the radio system, the distributed unit comprising at least one processor and at least one memory communicatively coupled to the at least one processor, and a radio unit of the cell, and a service, management and orchestration unit (SMO) of the cell, wherein the distributed unit, the radio unit, and the SMO are communicatively coupled to one another, wherein the distributed unit notifies the SMO of a capability of the distributed unit to reconfigure the radio unit, wherein the SMO makes a determination not to perform reconfiguration of the radio unit by the SMO, wherein the SMO confirms the capability of the distributed unit to the distributed unit, and wherein the distributed unit performs the reconfiguration of the radio unit instead of the SMO performing the reconfiguration of the radio unit.

The radio system of any preceding paragraph can comprise wherein the SMO omits locking of the cell from access by one or more user entities of the cell in connection with a notification, by the distributed unit to the SMO, of a reset of the radio unit.

The radio system of any preceding paragraph can comprise wherein the capability of the distributed unit to reconfigure the radio unit is a first capability, and wherein the distributed unit comprises a second capability to trigger the reconfiguration of the radio unit in response to a notification, by the radio unit to the distributed unit, of a reset of the radio unit, or in response to a detection, by the distributed unit, of the reset of the radio unit.

The radio system of any preceding paragraph can comprise wherein the distributed unit attempts to notify the SMO that the radio unit has been reset, and wherein, in response to determining there is a disconnected O1 connection between the SMO and the distributed unit, the distributed unit proceeds to perform the reconfiguration of the radio unit.

The radio system of any preceding paragraph can comprise wherein the distributed unit, prior to performing the reconfiguration of the radio unit, compares a first time stamp associated with detecting that the radio unit has been reset with a second time stamp associated with a current state of the radio unit, and wherein, in response to the distributed unit determining that the first time stamp and the second time stamp do not match, the distributed unit makes a determination to perform the reconfiguration of the radio unit based on a second parameter of the radio unit that is associated with the second time stamp, in place of a first parameter of the radio unit that is associated with the first time stamp.

A method can comprise determining, by a distributed unit of a cell of a radio system, that a radio unit of the cell has been reset, generating, by the distributed unit, a notification, communicated to the cell, that the radio unit has been reset, and based on the radio unit having been reset, reconfiguring, by the distributed unit, the radio unit.

The method of any preceding paragraph can comprise omitting, by a service, management and orchestration unit (SMO) of the cell, locking of the cell from access by one or more user devices connected via the cell, in response to receipt of the notification by the SMO. The method of any preceding paragraph can comprise wherein the determining that the radio unit of the cell has been reset comprises, determining, by the distributed unit, that an O1 connection between the SMO and the distributed unit is disconnected.

The method of any preceding paragraph can comprise determining, by the distributed unit, that a first time stamp associated with the determining that the radio unit has been reset does not match a second time stamp associated with a state of the radio unit prior to the reconfiguring of the radio unit.

The method of any preceding paragraph can comprise notifying, by the distributed unit, the SMO of a capability of the distributed unit to reconfigure the radio unit, and based on the capability of the distributed unit to reconfigure the radio unit, determining, by the SMO, not to perform reconfiguring of the radio unit by the SMO.

The method of any preceding paragraph can comprise determining, by the SMO, that the distributed unit is going to perform the reconfiguring of the radio unit in place of the SMO performing the reconfiguring of the radio unit.

### Example Operating Environment

FIG. 9 is a schematic block diagram of an operating environment 900 with which the described subject matter can interact. The system 900 comprises one or more remote component(s) 910. The remote component(s) 910 can be hardware and/or software (e.g., threads, processes, computing devices). In some embodiments, remote component(s) 910 can be a distributed computer system, connected to a local automatic scaling component and/or programs that use the resources of a distributed computer system, via communication framework 940. Communication framework 940 can comprise wired network devices, wireless network devices, mobile devices, wearable devices, radio access network devices, gateway devices, femtocell devices, servers, etc.

The system 900 also comprises one or more local component(s) 920. The local component(s) 920 can be hardware and/or software (e.g., threads, processes, computing devices). In some embodiments, local component(s) 920 can comprise an automatic scaling component and/or programs that communicate/use the remote resources 910 and 920, etc., connected to a remotely located distributed computing system via communication framework 940.

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 comprises a communication framework 940 that can be employed to facilitate communications between the remote component(s) 910 and the local component(s) 920, and can comprise an air interface, e.g., interface of a UMTS network, via a long-term evolution (LTE) network, etc. Remote component(s) 910 can be operably connected to one or more remote data store(s) 950, such as a hard drive, solid state drive, SIM card, device memory, etc., that can be employed to store information on the remote component(s) 910 side of communication framework 940. Similarly, local component(s) 920 can be operably connected to one or more local data store(s) 930, that can be employed to store information on the local component(s) 920 side of communication framework 940.

### Example Computing Environment

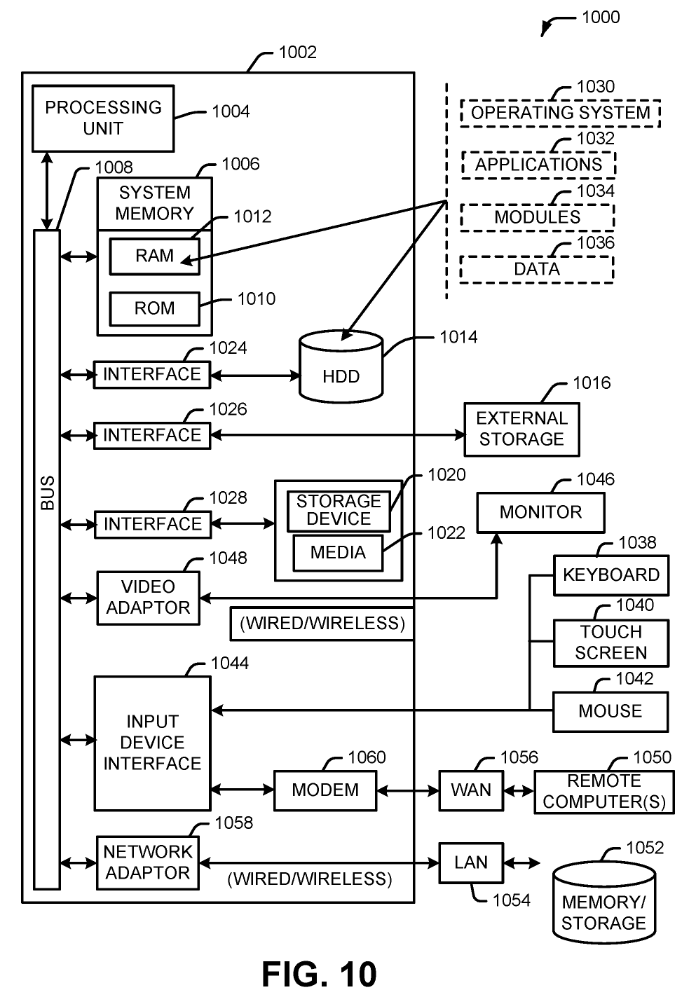

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can also be implemented in combination with other program modules and/or as a combination of hardware and software.

Generally, program modules include routines, programs, components, data structures, etc., that perform particular tasks or implement particular abstract data types. Moreover, the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal, such as a modulated data signal, e.g., a carrier wave or other transport mechanism, and include any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

Referring still to FIG. 10, the example computing environment 1000 which can implement one or more embodiments described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), and can include one or more external storage devices 1016 (e.g., a magnetic floppy disk drive (FDD) 1016, a memory stick or flash drive reader, a memory card reader, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014.

Other internal or external storage can include at least one other storage device 1020 with storage media 1022 (e.g., a solid state storage device, a nonvolatile memory device, and/or an optical disk drive that can read or write from removable media such as a CD-ROM disc, a DVD, a BD, etc.). The external storage 1016 can be facilitated by a network virtual machine. The HDD 1014, external storage device(s) 1016 and storage device (e.g., drive) 1020 can be connected to the system bus 1008 by an HDD interface 1024, an external storage interface 1026 and a drive interface 1028, respectively.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can occur at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. The network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### Conclusion

The above description of illustrated embodiments of the one or more embodiments described herein, comprising what is described in the Abstract, is not intended to be exhaustive or to limit the described embodiments to the precise forms described. While one or more specific embodiments and examples are described herein for illustrative purposes, various modifications are possible that are considered within the scope of such embodiments and examples, as those skilled in the relevant art can recognize.

In this regard, while the described subject matter has been described in connection with various embodiments and corresponding figures, where applicable, other similar embodiments can be used or modifications and additions can be made to the described embodiments for performing the same, similar, alternative, or substitute function of the described subject matter without deviating therefrom. Therefore, the described subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures to optimize space usage or enhance performance of user equipment. A processor can also be implemented as a combination of computing processing units.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. However, there is no intention to limit the various embodiments to the one or more specific forms described, but on the contrary, the intention is to cover all modifications, alternative constructions, and equivalents falling within the spirit and scope.

In addition to the various implementations described herein, other similar implementations can be used, or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A radio system, comprising:
a distributed unit of a cell of the radio system, the distributed unit comprising at least one processor and at least one memory communicatively coupled to the at least one processor; and
a radio unit of the cell,
wherein the distributed unit detects that the radio unit has been reset, and
wherein the distributed unit, in response to detecting that the radio unit has been reset, reconfigures the radio unit.

2. The radio system of claim 1, further comprising:
a service, management and orchestration unit (SMO) of the cell,
wherein the distributed unit notifies the SMO that the radio unit has been reset, and
wherein the SMO omits locking of the cell in connection with being notified by the distributed unit.

3. The radio system of claim 1, further comprising:
a service, management and orchestration unit (SMO) of the cell,
wherein the distributed unit notifies the SMO that the radio unit has been reset,
wherein the SMO determines that the distributed unit is able to proceed with reconfiguring the radio unit or that the SMO is able to proceed with the reconfiguring of the radio unit, and
wherein the SMO notifies the distributed unit that the distributed unit has been determined to be able to proceed with the reconfiguring of the radio unit or that the SMO has been determined to be able to proceed with the reconfiguring of the radio unit.

4. The radio system of claim 1, further comprising:
a service, management and orchestration unit (SMO) of the cell,
wherein the distributed unit notifies the SMO that the radio unit has been reconfigured.

5. The radio system of claim 1, further comprising:
a service, management and orchestration unit (SMO) of the cell,
wherein the distributed unit notifies the SMO of a capability of the distributed unit to reconfigure the radio unit, and
wherein the SMO confirms the capability of the distributed unit to the distributed unit.

6. The radio system of claim 1, wherein the distributed unit proceeds with reconfiguring the radio unit in response to the detecting that the radio unit has been reset.

7. The radio system of claim 1, further comprising:
a service, management and orchestration unit (SMO) of the cell,
wherein the distributed unit attempts to notify the SMO that the radio unit has been reset, and
wherein, in response to determining that an O1 connection between the SMO and the distributed unit is disconnected, the distributed unit proceeds with reconfiguring the radio unit.

8. The radio system of claim 1, wherein the radio unit is again reset after the distributed unit detects that the radio unit has been reset, and
wherein the distributed unit, prior to reconfiguring the radio unit, compares a first time stamp associated with the detecting that the radio unit has been reset with a second time stamp associated with a current state of the radio unit.

9. The radio system of claim 8, wherein, in response to the distributed unit determining that the first time stamp and the second time stamp do not match, the distributed unit determines to reconfigure the radio unit based on a second parameter of the radio unit that is associated with the second time stamp, in place of a first parameter of the radio unit that is associated with the first time stamp.

10. A radio system, comprising:
a distributed unit of a cell of the radio system, the distributed unit comprising at least one processor and at least one memory communicatively coupled to the at least one processor; and
a radio unit of the cell; and
a service, management and orchestration unit (SMO) of the cell,
wherein the distributed unit, the radio unit, and the SMO are communicatively coupled to one another,
wherein the distributed unit notifies the SMO of a capability of the distributed unit to reconfigure the radio unit,
wherein the SMO makes a determination not to perform reconfiguration of the radio unit by the SMO,
wherein the SMO confirms the capability of the distributed unit to the distributed unit, and
wherein the distributed unit performs the reconfiguration of the radio unit instead of the SMO performing the reconfiguration of the radio unit.

11. The radio system of claim 10, wherein the SMO omits locking of the cell from access by one or more user entities of the cell in connection with a notification, by the distributed unit to the SMO, of a reset of the radio unit.

12. The radio system of claim 10, wherein the capability of the distributed unit to reconfigure the radio unit is a first capability, and wherein the distributed unit comprises a second capability to trigger the reconfiguration of the radio unit in response to a notification, by the radio unit to the distributed unit, of a reset of the radio unit, or in response to a detection, by the distributed unit, of the reset of the radio unit.

13. The radio system of claim 10, wherein the distributed unit attempts to notify the SMO that the radio unit has been reset, and
wherein, in response to determining there is a disconnected O1 connection between the SMO and the distributed unit, the distributed unit proceeds to perform the reconfiguration of the radio unit.

14. The system of claim 10, wherein the distributed unit, prior to performing the reconfiguration of the radio unit, compares a first time stamp associated with detecting that the radio unit has been reset with a second time stamp associated with a current state of the radio unit, and
wherein, in response to the distributed unit determining that the first time stamp and the second time stamp do not match, the distributed unit makes a determination to perform the reconfiguration of the radio unit based on a second parameter of the radio unit that is associated with the second time stamp, in place of a first parameter of the radio unit that is associated with the first time stamp.

15. A method, comprising:
determining, by a distributed unit of a cell of a radio system, that a radio unit of the cell has been reset;
generating, by the distributed unit, a notification, communicated to the cell, that the radio unit has been reset; and
based on the radio unit having been reset, reconfiguring, by the distributed unit, the radio unit.

16. The method of claim 15, further comprising:
omitting, by a service, management and orchestration unit (SMO) of the cell, locking of the cell from access by one or more user devices connected via the cell, in response to receipt of the notification by the SMO.

17. The method of claim 15, further comprising:
wherein the determining that the radio unit of the cell has been reset comprises determining, by the distributed unit, that an O1 connection between the SMO and the distributed unit is disconnected.

18. The method of claim 15, further comprising:
determining, by the distributed unit, that a first time stamp associated with the determining that the radio unit has been reset does not match a second time stamp associated with a state of the radio unit prior to the reconfiguring of the radio unit.

19. The method of claim 15, further comprising:
notifying, by the distributed unit, the SMO of a capability of the distributed unit to reconfigure the radio unit; and
based on the capability of the distributed unit to reconfigure the radio unit, determining, by the SMO, not to perform reconfiguring of the radio unit by the SMO.

20. The method of claim 15, further comprising:
determining, by the SMO, that the distributed unit is going to perform the reconfiguring of the radio unit in place of the SMO performing the reconfiguring of the radio unit.
